(19) United States
(12) Patent Application Publication
(10) Pub. No.: US 2010/0157954 A1
(43) Pub. Date: Jun. 24, 2010

(54) Multicarrier Wireless Communication Method and Wireless Communication Apparatus

(75) Inventor: Yasushi Ogawa, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/516,541

(22) PCT Filed: Nov. 29, 2007
(86) PCT No.: PCT/JP2007/073047

§ 371 Date: Feb. 12, 2010

(30) Foreign Application Priority Data
Nov. 29, 2006 (JP) 2006-322391

(51) Int. Cl. H04J 3/00

(52) U.S. Cl. 370/336

(57) ABSTRACT

In the wireless communication apparatus of the present invention, channels which are used by a plurality of radio units 1 and 2 respectively and different from each other are selected from channels specified by carrier frequency and a time slot, and it is judged whether or not each of the selected channels interferes with another. Then, when it is judged that the channel does not interfere with one another, a usable channel is determined based on the channel. When usable channels are determined for a plurality of time slots in communication frames in a plurality of radio units 1 and 2, information of the usable channels is notified to the other side of communication. Therefore, it becomes possible, with use of a plurality of reasonable radio units having small-scaled circuit, that a channel suppressing interference is dynamically selected so as to perform high speed communication.

### CROSS REFERENCE TO RELATED APPLICATION

This application claims priority to and the benefit of Japan Patent Application No. 2006-322391 filed on Nov. 29, 2006, the entire content of which is incorporated herein by reference.

### TECHNICAL FIELD

The present invention relates to a multicarrier wireless communication method and wireless communication apparatus performing communication by a time division multiple access system adopting a multicarrier.

### BACKGROUND ART

Conventionally, a wireless communication terminal used for a communication system of a time division multiple access system adopting a multicarrier (hereinafter appropriately abbreviated as multicarrier TDD/TDMA system) comprises one radio unit and communicates wirelessly with a base station. However, communication using one radio unit limits the communication speed. Therefore, it is considered recently to improve the communication speed by providing one wireless communication terminal with a plurality of radio units and thus increasing the number of slots used in the same frame.

When a plurality of radio units are provided as above, there occurs a problem that communication quality is deteriorated due to interference between radio units. As a method of preventing this, it is conceivable that the performance of each radio unit is improved to boost interference resistance.

Moreover, as another prevention method, it is conceivable that a channel used by each radio unit is appropriately selected. As such method of selecting a channel is known, for example, one in which a plurality of network nodes are detected by a node having a network interface and RTT (Round Trip Time) of each channel is regularly measured by a probe message to estimate the channel quality, so that an optimum channel is selected after comparing those channel qualities (see Patent Document 1, for example).

Furthermore, as another method of selecting a channel is known one in which, for effectively sharing a frequency band between own wireless communication system and another wireless communication system, the usage of own wireless communication system is investigated for each channel which is to be possibly selected, and the usage of another wireless communication system is investigated by measuring the power of interference wave, thereafter a channel is selected (see Patent Document 2, for example), or one in which the frequency, bandwidth and power of interference wave are measured to find a frequency band to which a transmission line can be allocated, based on which and the frequency band of a reception line the frequency band of the transmission line is selected (see Patent Document 3, for example).

Patent Document 1: Japanese Patent Laid-Open No. 2004-289839

Patent Document 2: Japanese Patent Laid-Open No. 2002-186019

Patent Document 3: Japanese Patent Laid-Open No. 2003-70056

### SUMMARY OF INVENTION

### Technical Problem

However, the above method in which the performance of each radio unit is improved to boost interference resistance expands the circuit scale of each radio unit, which may lead to increase in radio cost.

Moreover, in the method disclosed in Patent Document 1, it is necessary to measure RTT of each channel for estimating the channel quality, so that the channel cannot be selected dynamically and thus communication delay may occur.

Moreover, in the method disclosed in Patent Document 2, the power of interference wave of each channel is measured to investigate usage of another wireless communication system, so that the channel cannot be selected dynamically and thus communication delay may occur similarly as in the case of Patent Document 1. Moreover, in the method disclosed in Patent Document 3, the frequency, bandwidth and power of interference wave are measured to find a frequency band to which a transmission line can be allocated, so that the channel cannot be selected dynamically and thus communication delay may occur similarly as in the case of Patent Documents 1 and 2. Furthermore, in this case, a circuit measuring the frequency, bandwidth and power of interference wave is required. Therefore, the circuit scale is expanded and the cost is increased, which may make it difficult to achieve this in a wireless communication terminal.

Therefore, an object of the present invention is to provide a multicarrier wireless communication method and wireless communication apparatus, which makes it possible that a plurality of reasonable radio units capable of decreasing a circuit scale can be used and a channel which is used by these plurality of radio units and suppresses interference can be dynamically selected with suppressing the occurrence of communication delay so as to perform high speed communication.

### Solution to Problem

A first aspect of the invention achieving the above object provides a multicarrier wireless communication method performing communication between a first wireless communication apparatus and a second wireless communication apparatus which have a plurality of radio units, using a plurality of carrier frequencies in a communication frame comprising a plurality of time-division multiplexed time slots, wherein

the first wireless communication apparatus comprises

a channel selection step of selecting a channel to be used by each of the plurality of radio units, wherein the channel is specified by the respectively different carrier frequency and the time slot when performing communication with the second wireless communication apparatus,

a judgment step of judging whether or not each channel selected at the channel selection step interferes with one another, and

a usable channel determination step of determining a usable channel based on the selected channel when it is judged at the judgment step that the channel does not interfere with one another; and

when the usable channels are determined for the plurality of time slots in the communication frame in the plurality of radio units, information of the usable channel is notified to the second wireless communication apparatus.

The second aspect of the invention provides the multicarrier wireless communication method according to the first aspect, wherein

the usable channel determination step determines a channel which has been judged not to interfere with one another at the judgment step as the usable channel when the usable channel is not determined for each time slot.

Furthermore, a third aspect of the invention achieving the above object provides a wireless communication apparatus having a plurality of radio units, with which performing communication with another wireless communication apparatus, using a plurality of carrier frequencies in a communication frame comprising a plurality of time-division multiplexed time slots, comprising

a channel selection unit selecting a channel to be used by each of the plurality of radio units, wherein the channel is specified by the respectively different carrier frequency and the time slot when performing communication with the another wireless communication apparatus,

a judgment unit judging whether or not each channel selected at the channel selection unit interferes with one another,

a usable channel determination unit determining a usable channel based on the channel which is determined not to interfere with one another by the judgment unit, and

a notification unit notifying the another wireless communication apparatus of information of the usable channel when the usable channels are determined for the plurality of time slots in the communication frame in the plurality of radio units.

### ADVANTAGEOUS EFFECTS ON INVENTION

According to the present invention, channels which are respectively used by a plurality of radio units and different one another are selected at the time of communication, and it is judged whether or not each of the selected channel interferes with one another. Then, when a channel does not interfere with one another, a usable channel is determined based on the channel. Therefore, it becomes possible, with use of a plurality of reasonable radio units having small-scaled circuit, that a channel suppressing interference is dynamically selected with suppressing the occurrence of communication delay so as to perform high speed communication.

### BRIEF DESCRIPTION OF DRAWINGS

FIG. 1 is a functional block diagram illustrating configuration of a main part of a wireless communication terminal according to an embodiment of the present invention.

FIG. 2 is a flowchart illustrating a schematic operation of the communication channel management unit shown in FIG. 1.

FIG. 3 is a flowchart illustrating the channel management information generation process in FIG. 2.

FIG. 4 is a flowchart illustrating the channel management information notification process in FIG. 2.

FIG. 5 is a flowchart illustrating a mask information update process performed by the communication channel management unit shown in FIG. 1.

FIG. 6 is a flowchart illustrating an active channel acquisition process by the wireless communication terminal shown in FIG. 1.

FIG. 7 is a flowchart illustrating a passive channel acquisition process by the wireless communication terminal shown in FIG. 1.

FIG. 8 is a flowchart illustrating relations between a multicarrier and a time slot and a channel for explaining concrete operation of the wireless communication terminal shown in FIG. 1.

FIG. 9 is a diagram illustrating a concrete example of communication channel selection sequences, common mask information, independent mask information and reference indexes generated and managed in the communication channel management unit shown in FIG. 1.

FIG. 10 is a diagram illustrating concrete operation of acquiring a communication channel.

FIG. 11 is a diagram illustrating concrete operation of acquiring a communication channel.

FIG. 12 is a diagram illustrating concrete operation of acquiring a communication channel.

FIG. 13 is a diagram illustrating concrete operation of acquiring a communication channel.

FIG. 14 is a diagram illustrating concrete operation of acquiring a communication channel.

### REFERENCE SIGNS LIST

1,2 radio unit
11,12 baseband unit
20 communication channel management unit
21,22 communication channel selection unit

### DESCRIPTION OF EMBODIMENTS

Preferred embodiments of the present invention will now be described with reference to the accompanying drawings.

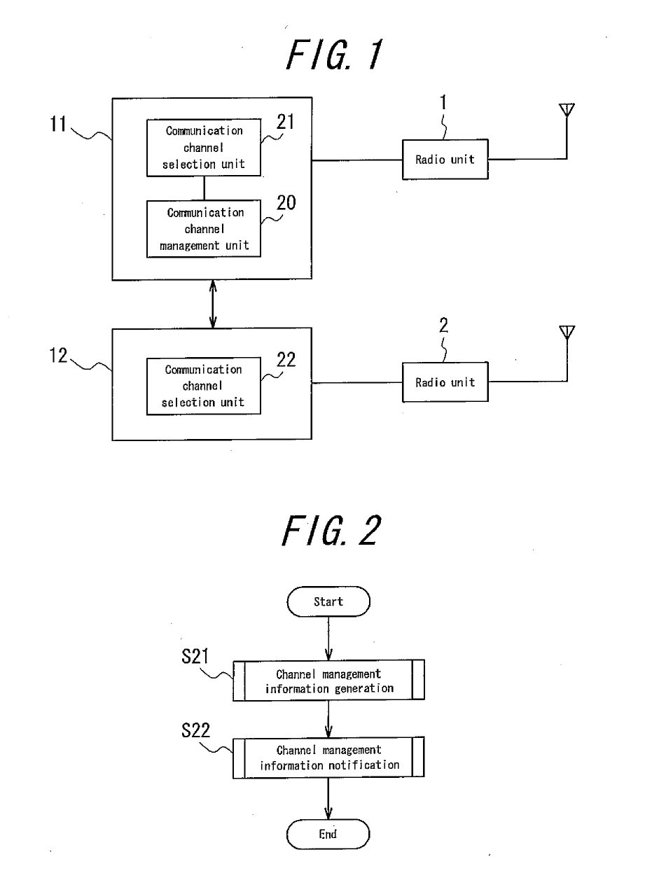

FIG. 1 is a functional block diagram illustrating configuration of a main part of a wireless communication terminal according to an embodiment of the present invention. The wireless communication terminal of the embodiment constitutes a first wireless communication apparatus and includes a plurality of radio units, with which there is performed wireless communication of multicarrier TDD/TDMA system with a base station, for example, which is a second wireless communication apparatus. In FIG. 1, two radio units 1 and 2 are provided as a plurality of radio units for simplifying the drawing. The radio unit 1 is controlled by a baseband unit 11 and the radio unit 2 is controlled by a baseband unit 12.

The baseband units 11 and 12 are connected to each other through an interface, manage communication channels used by corresponding radio units 1 and 2 and control so that a communication channel to be used is exclusively selected. In the embodiment, the baseband unit 11 is provided with a communication channel management unit 20 managing communication channels used by the radio units 1 and 2 and, further, the baseband units 11 and 12 are provided with communication channel selection units 21 and 22 selecting a channel based on management information of communication channel by the communication channel management unit 20 in the baseband unit 11.

The communication channel management unit 20 generates and manages communication channel selection sequences, common mask information showing usage of communication channel at all radio units and independent mask information showing usage of communication channel at each radio unit, as well as reference indexes used when each radio unit refers to a communication channel selection sequence.

Here, the communication channel selection sequence generates channel numbers available to all radio units in random order without overlapping. The communication channel selection units 21 and 22 combine this communication channel selection sequence and common mask information and independent mask information, which makes it possible to acquire a channel number available to a corresponding radio unit. Moreover, the reference index is generated for each radio unit with different index number from one another so that channel numbers in a communication channel selection sequence do not overlap among radio units.

Furthermore, the communication channel management unit 20 has interference bandwidth information which is valid when the use of a communication channel in a plurality of adjacent carriers because of interference is prohibited. The communication channel management unit 20 determines, based on the interference bandwidth information, the interference bandwidth of adjacent carriers with currently-used communication channel as a center, namely communication channels prohibited to be used by adjacent radio units. Therefore, the interference bandwidth including a communication channel used by another radio unit is marked as one which is prohibited from use.

Moreover, the reference index is updated by GPS synchronization time acquired through a base station or GPS synchronization time acquired directly from a GPS reception unit (not shown) provided in the terminal. Therefore, as to the reference index of radio units 1 and 2, the synchronization of the update timing is maintained, so that the updated index numbers are ones which are constantly deferent from each other and independent. It is noted that GPS synchronization time can update the reference index by synchronizing with a frame, as a frame time in a multicarrier TDD/TDMA system, for example.

The communication channel selection units 21 and 22 in the baseband units 11 and 12 notify the communication channel management unit 20 in the baseband unit 11 of acquired channel number every time they acquire communication channels. This notification leads the communication channel management unit 20 to update common mask information and independent mask information and to dynamically manage a channel range which can be selected as a communication channel. These updated common mask information and independent mask information are notified to the communication channel selection units 21 and 22 from the communication channel management unit 20.

FIGS. 2 to 7 are flowcharts illustrating schematic operation of the wireless communication terminal according to the above embodiment. The wireless communication terminal performs connection process between itself and a base station before communicating with the base station. At that time, the communication channel management unit 20 performs a channel management information generation process (Step S21) generating channel management information, as shown in FIG. 2, and then performs a channel management information notification process (Step S22) notifying the communication channel selection units 21 and 22 of the generated channel management information.

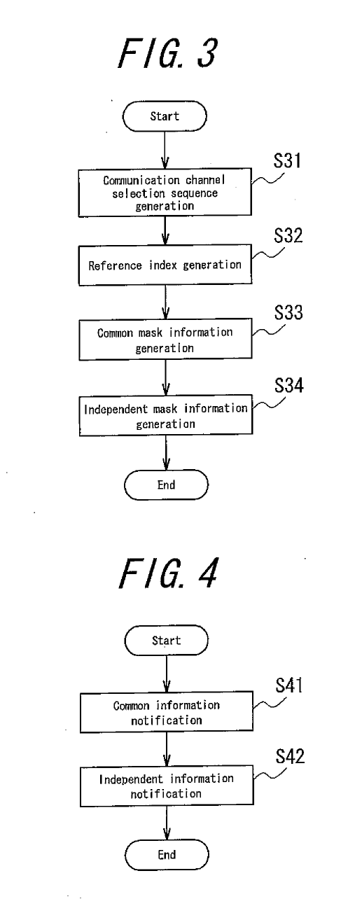

In the channel management information generation process at Step S21, as shown in FIG. 3, the communication channel management unit 20 performs communication channel selection sequence generation process (Step S31), reference index generation process (Step S32), common mask information generation process (Step S33) and independent mask information generation process (Step S34). Moreover, in the channel management information notification process at Step S22 in FIG. 2, as shown in FIG. 4, the communication channel management unit 20 notifies both of the communication channel selection units 21 and 22 of a communication channel selection sequence and common mask information which are shared information of radio units 1 and 2 (Step S41) and notifies corresponding communication channel selection units 21 and 22 of a reference index and independent mask information which are independent information of radio units 1 and 2 (Step S42).

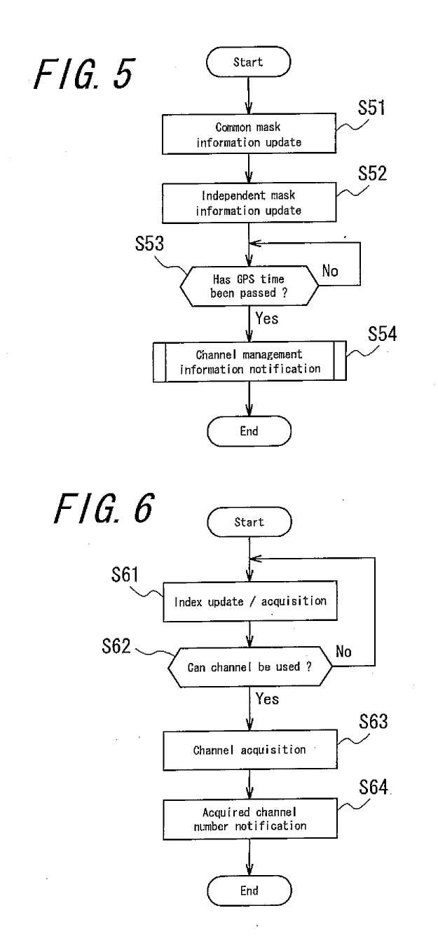

Moreover, the communication channel management unit 20 receives notification of acquired channel number from the communication channel selection unit 21 or 22 and then performs mask information update process shown in FIG. 5. That is, the communication channel management unit 20 updates common mask information so that a state of a newly acquired channel indicates that the channel has been already acquired (Step S51), while as to independent mask information, independent mask information at the channel acquisition side is updated in terms of communication channel having been already acquired and independent mask information at the non channel acquisition side is updated in terms of acquired mask and interference bandwidth (Step S52). Thereafter, at the time when GPS synchronization time has passed (Step S53), the communication channel management unit 20 notifies the communication channel selection units 21 and 22 of channel management information including updated common mask information and independent mask information (Step S54).

The wireless communication terminal of the embodiment may be divided to a case that the terminal actively acquires communication channels used by the radio units 1 and 2 (active channel acquisition process) and a case that the terminal passively acquires them in response to a communication channel acquisition request in which the channel is specified by the base station (passive channel acquisition process).

First in the active channel acquisition process, the communication channel management unit 20 makes an active channel acquisition request to the communication channel selection units 21 and 22. Then, the communication channel selection units 21 and 22 select a channel number in a communication channel selection sequence indicated by a reference index (Step S61), compares the selected channel number with independent mask information to determine whether the selected channel number can be selected or not, i.e., the channel can be used or not (Step S62).

As a result, when it is judged that the channel can be selected, the communication channel selection units 21 and 22 acquire the channel as a communication channel (Step S63) and notifies the communication channel management unit 20 of the acquired channel number (Step S64). When the communication channel selection units 21 and 22 determine at Step S62 that the channel cannot be selected, on the other hand, the process goes to Step S61, at which the reference index is updated during the next GPS synchronization time, and then a possible communication channel is newly selected from the communication channel selection sequence and it is judged whether or not the channel can be selected.

Each of radio units 1 and 2 acquires a communication channel which can be used in each time slot and does not interfere with each other, as above, and notifies the base station of information about the acquired channel which can be used. Thereby, the terminal can start communication with the base station using a part or whole of the communication channel.

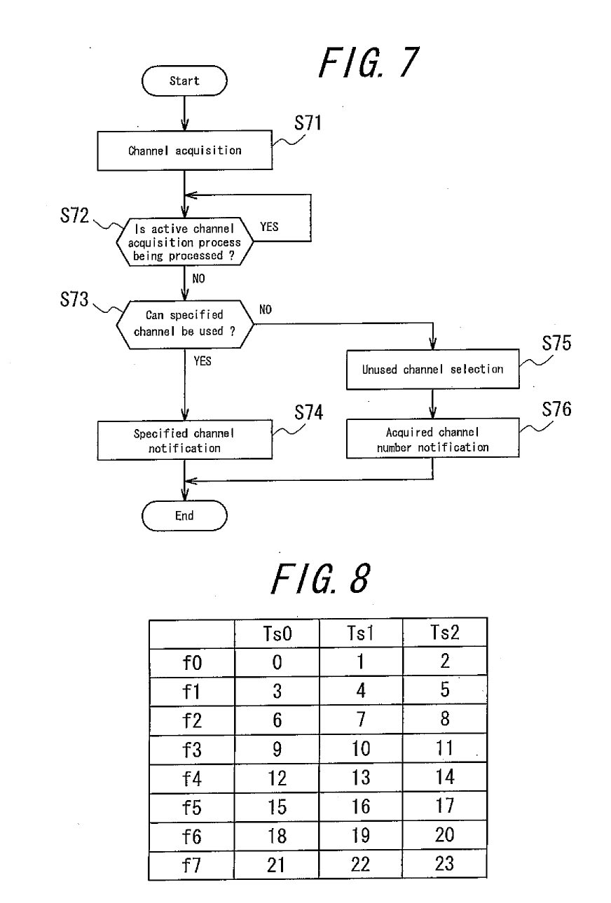

On the other hand, when the wireless communication terminal receives a communication channel acquisition request in which the channel is specified by the base station (Step S71) and the active channel acquisition process is not being processed in the communication channel management unit 20 at the time, the passive channel acquisition process is performed (Step S72), as shown in FIG. 7. It is noted that, when the active channel acquisition process is being processed, the communication channel management unit 20 renders the passive channel acquisition process pending in response to a channel request from the base station until the active channel acquisition process is completed. Thus, the passive channel acquisition process is performed after channel management information is updated by completion of the active channel acquisition process.

First in the passive channel acquisition process, the communication channel management unit 20 determines whether or not the channel specified by the base station can be used (Step S73). Here, when the specified channel can be used, the communication channel management unit 20 notifies the communication channel selection units 21 and 22 of a specified channel acquisition request. Thus, the communication channel selection units 21 and 22 perform communication channel acquisition process based on the specified channel and notify the communication channel management unit 20 of the specified channel number which has been acquired (Step S74).

When it is judged at Step S73 that the channel specified by the base station cannot be used, on the other hand, the communication channel management unit 20 shifts the process to the active channel acquisition process and makes a communication channel acquisition request to the communication channel selection units 21 and 22. Thus, the communication channel selection units 21 and 22 select an unused channel (Step S75) and notify the communication channel management unit 20 of the acquired channel number (Step S76). It is noted that, when the channel specified by the base station cannot be used, the communication channel management unit 20 shifts the process to the active channel acquisition process, and can also ignore a communication channel acquisition request in which the channel is specified by the base station without acquiring any unused channel.

In the embodiment, therefore, the communication channel selection units 21 and 22 constitute a channel selection unit, a judgment unit and a usable channel determination unit, and the baseband unit 11 and the corresponding radio unit 1 or the baseband unit 12 and the corresponding radio unit 2 form a notification unit.

Next, a concrete operation of acquiring communication channel by active channel acquisition process will be described with reference to FIGS. 8 to 14. FIG. 8 is a diagram illustrating relations between the multicarrier and time slot which can be used in the radio units 1 and 2 and channel. It is supposed here that the carriers (frequency) which can be used are 8 carriers of f0 to f7, and the number of time slots in TDMA is 3 of Ts0 to Ts2, in addition, the channel numbers 0 to 23 which correspond to the carriers and slots can be used.

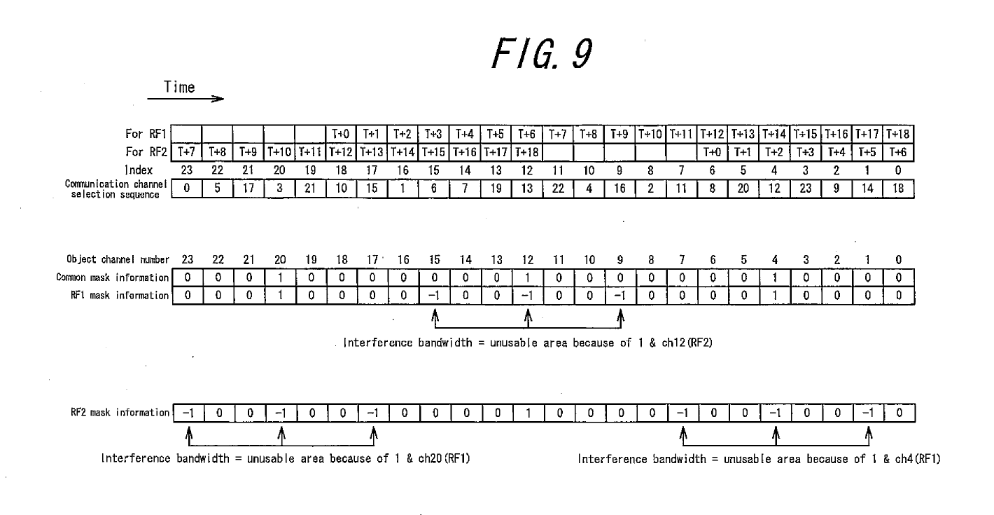

FIG. 9 is a diagram illustrating the communication channel selection sequence, common mask information, independent mask information and the reference index which are generated and managed by the communication channel management unit 20. It is noted that RF1 indicates the radio unit 1 and RF2 indicates the radio unit 2 in FIG. 9. The reference index for RF1 and the reference index for RF2 are sequentially updated as “T+0”, “T+1” . . . with respect to each GPS synchronization time. The communication channel selection sequence indicated by these reference indexes is generated in random order.

Moreover, in RF1 mask information and RF2 mask information which are independent mask information, “1” indicates a communication channel (ch) having been acquired by the own RF, “−1” indicates an unusable communication channel because of interference bandwidth of another RF and “0” indicates an unused channel. It is supposed here that channel numbers in a carrier which is used by another RF and one before and after the carrier in the same slot are rendered to be channel numbers which cannot be used because of interference (unusable area).

Therefore, RF1 has acquired the channel numbers “20” and “4” in FIG. 9, and thus RF2 mask information shows “−1” for the channel numbers “23”, “20” and “17” with corresponding to the channel number “20” of RF1 and “−1” for the channel numbers “7”, “4” and “1” with corresponding to the channel number “4” of RF1. Similarly, RF2 has acquired the channel numbers “12”, and thus RF1 mask information shows “−1” for the channel numbers “15”, “12” and “9”.

As to common mask information, moreover, the channel numbers “20” and “4” used by RF1 and the channel number “12” used by RF2 are shown as “1” respectively.

All channels are unused before the wireless communication terminal starts communication with the base station. As to the start of active channel acquisition process “T+0”, therefore, the channel number “10” is selected from the communication channel selection sequence indicated by the reference index for RF1 “18” in the RF1 side, while the channel number “8” is selected from the communication channel selection sequence indicated by the reference index for RF2 “6” in the RF2 side, as shown in FIG. 9. In this case, the carrier of the channel number “10” is “f3” and the carrier of the channel number “8” is “f2”, so that both carriers are adjacent to each other. However, they do not interfere with each other since the time slot is different.

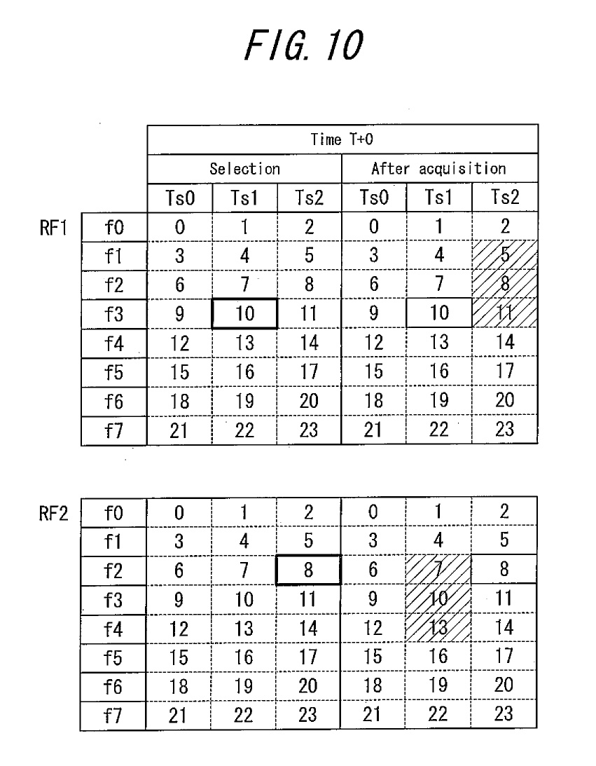

In this case, therefore, the selected channel number “10” is acquired as a usable channel in the RF1 side and, similarly, the selected channel number “8” is acquired as a usable channel in the RF2 side, as shown in FIG. 10. Moreover, in RF1 mask information the channel numbers “5”, “8” and “11” are set as interference bandwidth since RF2 has acquired the channel number “8”, while in RF2 mask information the channel numbers “7”, “10” and “13” are set as interference bandwidth since RF1 has acquired the channel number “10”. The interference bandwidth is shown by areas with diagonal lines in FIGS. 10 to 14.

As to the next GPS synchronization time “T+1”, the channel number “15” is selected from the communication channel selection sequence indicated by the reference index for RF1 “17” in the RF1 side, while the channel number “20” is selected from the communication channel selection sequence indicated by the reference index for RF2 “5” in the RF2 side.

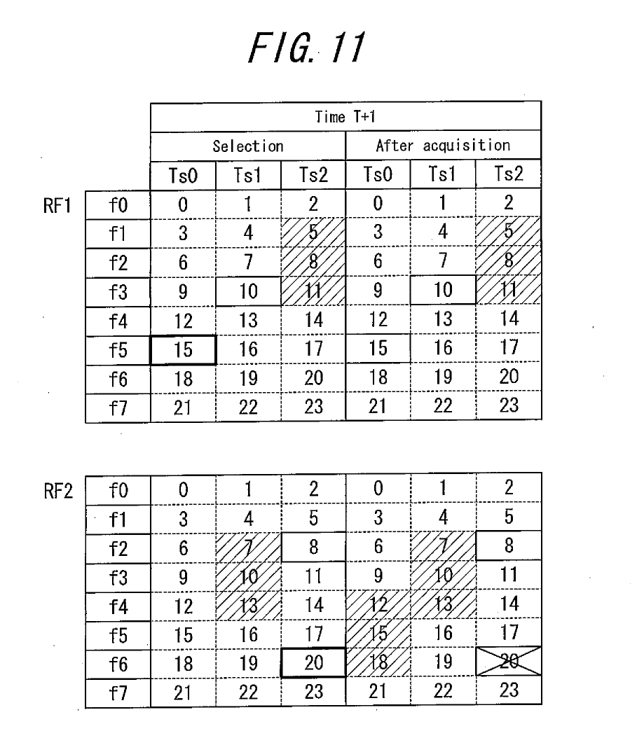

In this case, the selected channel “15” is acquired as a usable channel in the RF1 side, while in the RF2 side the selected channel number “20” is in the same slot Ts2 as the channel number “8” which has been already acquired as a usable channel, so that the channel is not acquired as a usable channel, as shown in FIG. 11. The channel numbers which are not acquired even if selected are shown with “x” symbol in FIGS. 11 to 14.

As to the state of usable channels at this point, therefore, the channel numbers “10” and “15” are usable in the RF1 side, while only channel number “8” acquired in GPS synchronization time “T+0” is usable in the RF2 side. Moreover, the channel with channel number “15” is added as a usable channel in the RF1 side, and thus the channel numbers “12”, “15” and “18” are additionally set as interference bandwidth in RF2 mask information.

As to the next GPS synchronization time “T+2”, the channel number “1” is selected from the communication channel selection sequence indicated by the reference index for RF1 “16” in the RF1 side, while the channel number “12” is selected from the communication channel selection sequence indicated by the reference index for RF2 “4” in the RF2 side.

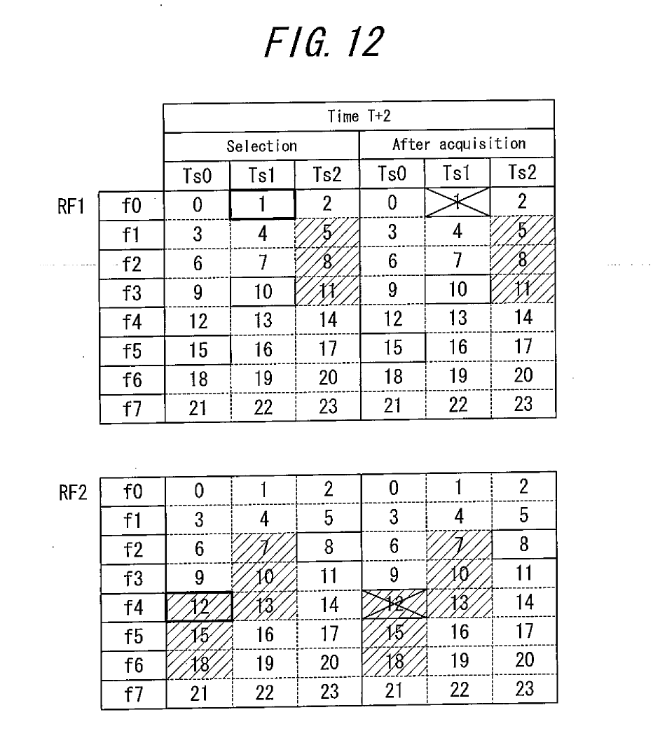

In this case, in the RF1 side the selected channel number “1” is in the same slot Ts1 as the channel number “10” which has been already acquired as a usable channel, so that the channel is not acquired as a usable channel, as shown in FIG. 12. In the RF2 side, moreover, the selected channel number “12” is in the interference bandwidth of the channel number “15” which has been already acquired in the RF1 side as a usable channel, so that the channel is similarly not acquired as a usable channel.

Therefore, the state of usable channels at this point is the same as in the case of GPS synchronization time “T+1” shown in FIG. 11.

As to the next GPS synchronization time “T+3”, the channel number “6” is selected from the communication channel selection sequence indicated by the reference index for RF1 “15” in the RF1 side, while the channel number “23” is selected from the communication channel selection sequence indicated by the reference index for RF2 “3” in the RF2 side.

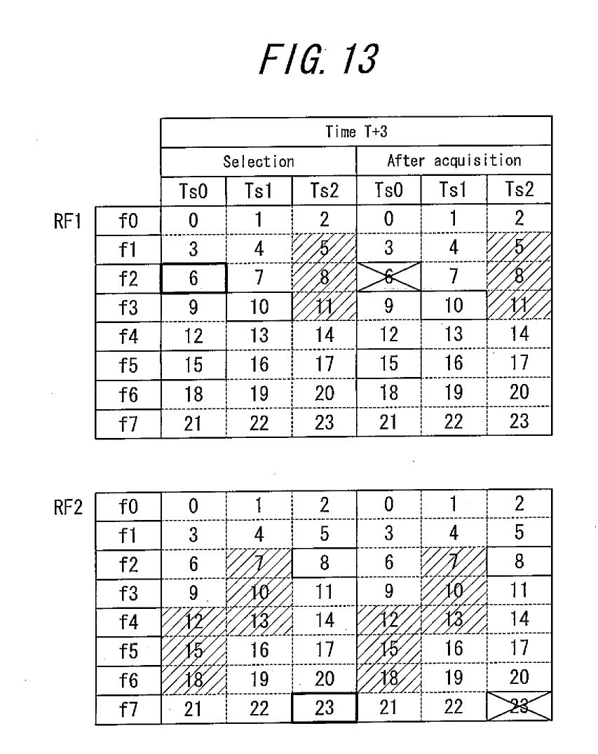

In this case, in the RF1 side the selected channel number “6” is in the same slot Ts0 as the channel number “15” which has been already acquired as a usable channel, so that the channel is not acquired as a usable channel, as shown in FIG. 13. Similarly in the RF2 side, the selected channel number “23” is in the same slot Ts2 as the channel number “8” which has been already acquired as a usable channel, so that the channel is not acquired as a usable channel.

Therefore, the state of usable channels at this point is the same as in the case of GPS synchronization time “T+2” shown in FIG. 12, i.e., the case of GPS synchronization time “T+1” shown in FIG. 11.

As to the next GPS synchronization time “T+4”, the channel number “7” is selected from the communication channel selection sequence indicated by the reference index for RF1 “14” in the RF1 side, while the channel number “9” is selected from the communication channel selection sequence indicated by the reference index for RF2 “2” in the RF2 side.

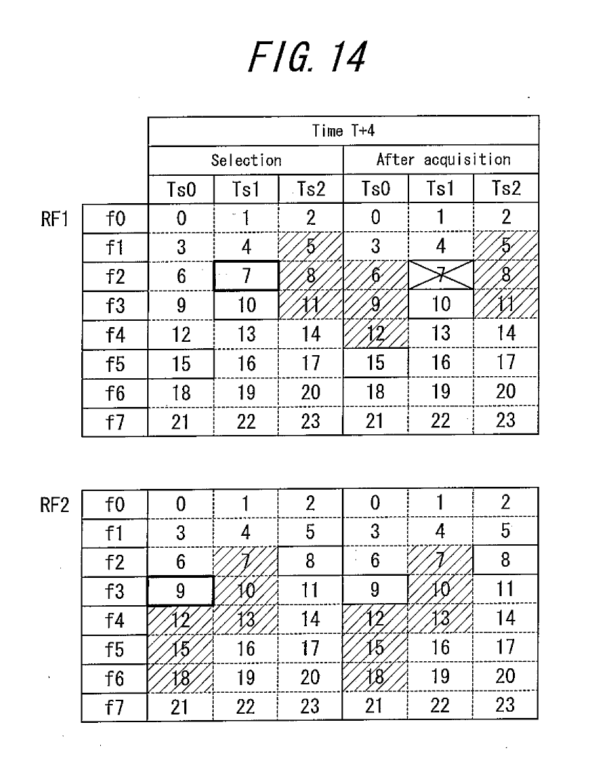

In this case, in the RF1 side the selected channel number “7” is in the same slot Ts1 as the channel number “10” which has been already acquired as a usable channel, so that the channel is not acquired as a usable channel, as shown in FIG. 14. In the RF2 side, on the other hand, the time slot Ts0 in which the selected channel number “9” is set is different from the time slot Ts2 in which the channel number “8” having been already acquired as a usable channel is set and, further, the channel number “9” is not in the interference bandwidth of the usable channel of RF1 side, Therefore, the channel is acquired as a usable channel.

As to the state of usable channels at this point, therefore, communication channels with channel number “10” and “15” are usable in the RF1 side, while the communication channel with channel number “9” is added besides one with channel number “8” in the RF2 side. Moreover, the communication channel with channel number “9” is added as a usable channel in the RF2, and thus the channel numbers “6”, “9” and “12” are additionally set as interference bandwidth in RF1 mask information.

Thereafter, the above operation is to be repeated until a usable channel is acquired for the time slot Ts2 where the usable channel has not been determined in the RF1 side and until a usable channel is acquired for the time slot Ts1 where the usable channel has not been determined in the RF2 side. Then, in each side of RF1 and RF2, the channel acquisition process is terminated at the time when usable channels are acquired for all time slots. The information of acquired usable channels is notified to the base station from the radio unit 1 or the radio unit 2, and the terminal starts wireless communication of TDD/TDMA system with the base station using a part or whole of the communication channel.

According to the embodiment, when communication with a base station is performed, there is dynamically and exclusively acquired a usable channel which is not set in a same time slot and nor in interference bandwidth of a channel used by another radio unit, with respect to each GPS synchronization time in each of the radio units 1 and 2. Therefore, it is possible to obtain each radio unit 1 and 2 having small-scaled circuit and thus reduce cost, and to perform high speed communication with suppressing communication delay.

It is noted that the present invention is not limited to the above embodiment, and many variations and modifications can be implemented. For example, two radio units are provided in the above embodiment, while the number of radio units is not limited to two and may be three or more. Moreover, the present invention can be widely applied to wireless communication methods and wireless communication apparatuses of multicarrier TDD/TDMA system, and the number of carriers and time slots used are not limited to ones shown in the above embodiment.

1. A multicarrier wireless communication method performing communication between a first wireless communication apparatus and a second wireless communication apparatus which have a plurality of radio units, using a plurality of carrier frequencies in a communication frame comprising a plurality of time-division multiplexed time slots, wherein
the first wireless communication apparatus comprises
a channel selection step of selecting a channel to be used by each of the plurality of radio units, wherein the channel is specified by the respectively different carrier frequency and the time slot when performing communication with the second wireless communication apparatus,
a judgment step of judging whether or not each channel selected at the channel selection step interferes with one another, and
a usable channel determination step of determining a usable channel based on the selected channel when it is judged at the judgment step that the channel does not interfere with one another; and
when the usable channels are determined for the plurality of time slots in the communication frame in the plurality of radio units, information of the usable channel is notified to the second wireless communication apparatus.

2. The multicarrier wireless communication method according to claim 1, wherein
the usable channel determination step determines a channel which has been judged not to interfere with one another at the judgment step as the usable channel when the usable channel is not determined for each time slot.

3. A wireless communication apparatus having a plurality of radio units, with which performing communication with another wireless communication apparatus, using a plurality of carrier frequencies in a communication frame comprising a plurality of time-division multiplexed time slots, comprising
a channel selection unit selecting a channel to be used by each of the plurality of radio units, wherein the channel is specified by the respectively different carrier frequency and the time slot when performing communication with the another wireless communication apparatus,
a judgment unit judging whether or not each channel selected at the channel selection unit interferes with one another,
a usable channel determination unit determining a usable channel based on the channel which is determined not to interfere with one another by the judgment unit, and
a notification unit notifying the another wireless communication apparatus of information of the usable channel when the usable channels are determined for the plurality of time slots in the communication frame in the plurality of radio units.
